(19) United States
(12) Patent Application Publication
(10) Pub. No.: US 2016/0149778 A1
(43) Pub. Date: May 26, 2016

(54) APPLICATION UPGRADE FEASIBILITY AND SUPPORT

(71) Applicant: SugarCRM Inc., Cupertino, CA (US)

(72) Inventors: Stanislav Malyshev, San Jose, CA (US); Zac Sprackett, Kanata (CA); Jelle Vink, Gilroy, CA (US); Paul Huang, Sunnyvale, CA (US); Artem Vysotsky, Redwood City, CA (US)

(21) Appl. No.: 14/554,329

(22) Filed: Nov. 26, 2014

(51) Int. Cl. H04L 12/26; G06F 17/22

(52) U.S. Cl. CPC H04L 43/065; G06F 17/2235; H04L 43/08

(57) ABSTRACT

Embodiments of the invention provide a method, system and computer program product for upgrade feasibility and reporting. In an embodiment of the invention, a method for application upgrade feasibility and reporting includes generating in memory of a computing system a deployment characterization of a customized instance of a computer program designated to receive an upgrade. The method also includes comparing the deployment characterization to a selection of known characterizations of deployment of different customized instances of the computer program, each of the characterization having an association with an upgrade feasibility predictor for the upgrade. The method yet further includes identifying a matching one of the known characterizations for the generated deployment characterization. Finally, the method includes displaying a report on a display of the computing system including an upgrade feasibility predictor corresponding to the matching one of the known characterization.

### BACKGROUND OF THE INVENTION

1. Field of the Invention

The present invention relates to software upgrades and more particularly to upgrading customized instances of a computer program.

2. Description of the Related Art

The software lifecycle begins with the development of a computer program and the testing and subsequent deployment of the computer program to one or more end users. Once deployed, the lifecycle continues with the performance of periodic upgrades and enhancements and the repair of discovered flaws in the computer program. For individual computer programs fixed in form at the time of deployment and installed in a uniform platform type, applying upgrades and enhancements to the deployed application can be as simple as providing copies of a single file or set of files to different end users for installation in place of an existing file or set files, or in the alternative, for patching an existing file or set of files. The ease of applying upgrades and enhancements, however, varies in consideration of the potential for different platform types supporting the deployed computer program.

In this regard, with the advent of different computing platforms including those supporting a Windows™ type operating system, a Mac™ OS type operating system or Linux type operating system, the files or set of files for a deployed application differ. Therefore, as a prerequisite to performing an upgrade of a platform specific deployment of a computer program, first the specific platform must be identified such that the correct set of files may be provided as an upgrade to an existing deployment on the specific platform. Notwithstanding, the process of performing an upgrade yet further can be complicated in consideration of the different supporting computing component types upon which the deployed application is dependent, such as different database management systems, Web servers, and the like. As in the case of differing supporting operating platforms, though, providing the correct file or set of files to upgrade a deployed application can simply require a determination of the specific platform type and the identity of the specific component types upon which the deployed application is dependent.

The process of performing an upgrade to a computer program, though, can become orders of magnitude more complex when considering the possibility that the end user may have performed customized modifications to the underlying program code of the deployed computer program. In an era of open source computing, so much has become common. As such, the indiscriminate upgrading of a customized deployment of a computer program oftentimes can “break” the deployment resulting in a costly rolling back of the upgrade. Of course, advanced testing of an upgrade across a selection of customized deployments can help to reduce the likelihood of a failed upgrade, as can robust documentation describing the potential impact of applying the upgrade. Yet, even in consideration of caution and diligence, the process of upgrading a customized deployment of a computer program is rife with risk.

### BRIEF SUMMARY OF THE INVENTION

Embodiments of the present invention address deficiencies of the art in respect to upgrading a computer program and provide a novel and non-obvious method, system and computer program product for upgrade feasibility and reporting. In an embodiment of the invention, a method for application upgrade feasibility and reporting includes generating in memory of a computing system a deployment characterization of a customized instance of a computer program designated to receive an upgrade. The method also includes comparing the deployment characterization to a selection of known characterizations of deployment of different customized instances of the computer program, each of the characterization having an association with an upgrade feasibility predictor for the upgrade. The method yet further includes identifying a matching one of the known characterizations for the generated deployment characterization. Finally, the method includes displaying a report on a display of the computing system including an upgrade feasibility predictor corresponding to the matching one of the known characterization. In this regard, the upgrade feasibility predictor can include an indicator such as “recommended”, “not recommended”, or “recommended with caution”.

In one aspect of the embodiment, the deployment characterization includes an inventory of components included as part of the customized instance of the computer program. In another aspect of the embodiment, the deployment characterization includes an inventory of components upon which the instance of the computer program is dependent. In yet another aspect of the embodiment, the deployment characterization includes an inventory of ones of the components that have been modified from a default form of the components. Finally, in even yet another aspect of the embodiment, a hyperlinked reference to crowd-sourced documentation pertaining to particular upgrade issues for the deployment characterization arising from attempting the upgrade is included in the report.

In another embodiment of the invention, an application deployment data processing system is configured for application upgrade feasibility and reporting. The system includes a host computing system that includes at least one computer with memory and at least one processor. The system also includes a data store coupled to the host computing system and a customized instance of a computer program including one or more components stored in the data store. Finally, the system includes an upgrade feasibility module executing in the memory of the host computing system.

The module includes program code enabled upon execution by the at least one processor to generate in the memory a deployment characterization of the customized instance of the computer program designated to receive an upgrade, to compare the deployment characterization to a selection of known characterizations of deployment of different customized instances of the computer program stored in the data store, each of the characterization having an association with an upgrade feasibility predictor for the upgrade, to identify a matching one of the known characterizations for the generated deployment characterization and to display a report on a display of the host computing system including an upgrade feasibility predictor corresponding to the matching one of the known characterization.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for application upgrade feasibility and reporting;

FIG. 2 is a schematic illustration of a application deployment data processing system configured for application upgrade feasibility and reporting; and,

FIG. 3 is a flow chart illustrating a process for application upgrade feasibility and reporting.

### DETAILED DESCRIPTION OF THE INVENTION

Embodiments of the invention provide for application upgrade feasibility and reporting. In accordance with an embodiment of the invention, a customized instance of a computer program can be analyzed to produce a deployment characterization. The analysis can include an inventory of components included as part of the customized instance of the computer program, an inventory of components upon which the instance of the computer program is dependent, and an inventory of ones of the components that have been modified from a default form of the components. Thereafter, the deployment characterization can be compared to known characterizations, each known characterization being associated with an upgrade feasibility predictor for an upgrade to be applied to the computer program, such as recommended, not recommended, or recommended with caution. Finally, a report can be generated indicating the upgrade feasibility predictor for the upgrade. Optionally, a hyperlinked reference to crowd-sourced documentation pertaining to particular upgrade issues for the deployment characterization arising from attempting the upgrade can be displayed in the report.

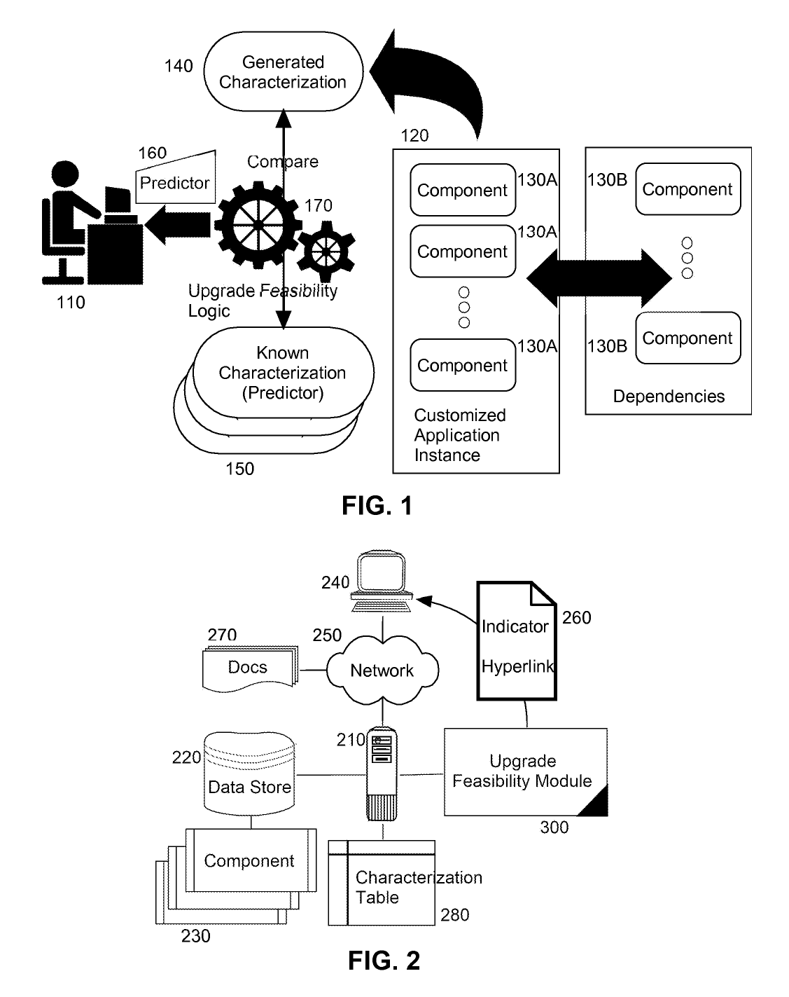

In further illustration, FIG. 1 pictorially shows a process for application upgrade feasibility and reporting. As shown in FIG. 1, an end user 110 can direct upgrade feasibility logic 170 to assess the feasibility of upgrading a customized application instance 120 that includes one or more components 130A, for instance separate compartmentalized logical components, object files, source code files, or resource files, to name a few examples. The upgrade feasibility logic 170 can generate a deployment characterization 140 based upon any of an inventory of the components 130A, an inventory of those of the components 130A that differ from a default form of the components 130A (e.g. any customized ones of the components 130A), or any components 130B upon which the customized application instance 120 depends, such as a particular database management system, Web server or application server, to name three examples.

The upgrade feasibility logic 170 thereafter can compare the generated characterization 140 to pre-stored known characterizations 150, each with a corresponding predictor of the likelihood of success of upgrading an application instance demonstrating a similar or identical generated characterization. Once the upgrade feasibility logic 170 has identified one or more of the known characterizations 150 as matching the generated characterization 140, the upgrade feasibility logic 170 can retrieve each predictor associated with an identified one of the characterizations 150. The upgrade feasibility logic 170 in turn can incorporate each retrieved predictor 160 into a report of the feasibility of performing the upgrade and the report can be displayed to the end user 110.

The process described in connection with FIG. 1 can be implemented in an application deployment data processing system. In further illustration, FIG. 2 schematically shows an application deployment data processing system configured for application upgrade feasibility and reporting. The system can include a host computing system 210 that can include one or more computing devices each with memory and at least one processor. The host computing system 210 can include a data store 220 of different components 230 forming a customized instance of an application deployed in the host computing system 210. The host computing system 210 further can be communicatively coupled to an end user 240 over computer communications network from which the host computing system 210 can receive a directive to report upon the upgrade feasibility of a customized form of an application instance.

The host computing system 210 also can include a characterization table 280 that includes different known characterizations of respectively different customized forms of the instance of the application. Each different known characterization also can include an upgrade feasibility predictor, for instance “recommended”, “not recommended”, or “recommended with caution”. Each predictor can be assigned statically by an administrator, or the predictor can be assigned dynamically based upon data provided subsequent to the attempted upgrading of a customized form of the application instance. In the latter circumstance, after each attempt at upgrading a customized instance of the application having a particular generated characterization, an entry in the characterization table 280 can be updated to indicate the result of the attempt at upgrading. To the extent that the generated characterization does not exist in the characterization table 280, a new entry can be created in the characterization table 280 with a predictor corresponding to the result of the attempt at upgrading.

Importantly, an upgrade feasibility module 300 can be included and can execute within the memory of the host computing system 210. It will be recognized by the skilled artisan that the physical computing device of the host computing system 210 upon which the customized instance of the application executes may differ from the physical computing device of the host computing system 210 in which the upgrade feasibility module 300 executes and within which the characterization table 280 is stored. The upgrade feasibility module 300 includes program code that when executed in the memory of the host computing system 210, is enabled to respond to the directive of the end user 240 to generate a deployment characterization for the components 230 of the customized instance of the application. The program code of the upgrade feasibility module 300 also is enabled to compare the generated characterization to those known characterizations of the characterization table 280. Thereafter, the program code of the upgrade feasibility module 300 is enabled to generate a report 260 with or more predictors associated with corresponding matching known characterizations.

Of note, as an option, one or more crowd-sourced documents 270 can be located over computer communications network 250 that pertain to the corresponding matching known characterizations. The documents 270 can include, for instance, end user reports of the successes and failures of upgrading an instance of the application having a matching characterization, pitfalls, tips, recommendations and the like. Thereafter, one or more hyperlinks to the located documents 270 can be inserted into the report 260 which in turn can be returned to the end user 240 over the computer communications network 250.

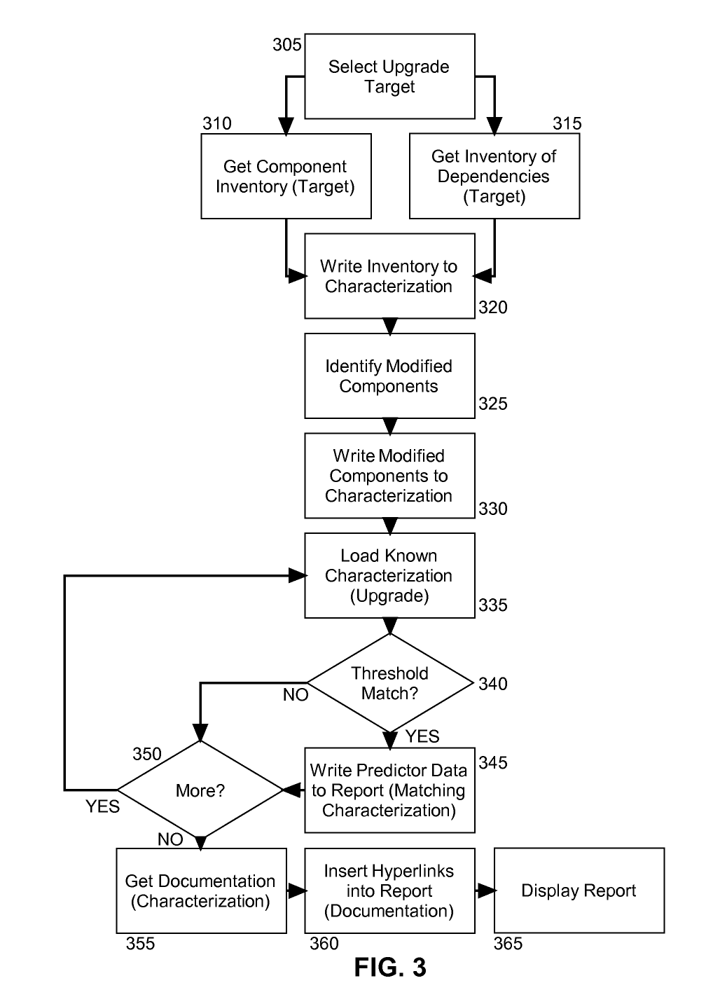

In even yet further illustration of the operation of the upgrade feasibility module, FIG. 3 is a flow chart illustrating a process for application upgrade feasibility and reporting. Beginning in block 305, a target customized instance of an application can be selected for upgrading. Subsequently, in block 310 an inventory of the respective components forming the customized instance of the application can be retrieved. Also, in block 315 an inventor of components upon which the customized instance of the application is dependent can be retrieved. Thereafter, in block 320, the inventory can be written to a characterization data structure in memory and optionally persisted to a file.

In block 325, those of the components forming the customized instance of the application that have been modified can be identified. For instance, the source code of each of the components can be compared to source code for default forms of the same component. Alternatively, a checksum or hash value can be computed for each of the components and compared to a checksum or hash value for a corresponding default form of the same component. Subsequently, in block 330 a list of those of the components that are modified from the default form of the same component can be written to the characterization.

In block 335, the characterization generated in blocks 310 through 330 can be compared to one or more previously stored, known characterizations. In decision block 340, it can be determined if a first one of the known characterizations matches by a threshold the generated characterization. If so, in block 345 an associated predictor can be retrieved from the matching known characterization and inserted into a report. Thereafter, in decision block 350 it can be determined if additional known characterizations remain to be compared to the generated characterization. If not, in block 355 one or more documents associated with the matching known characterizations can be retrieved and in block 360, hyperlink references to each of the documents can be inserted into the report. Finally, in block 365 the report can be returned to the end user.

Of note, the report itself can be used for many purposes. In its base form, the report simply can form an advisory tool for use by an upgrading administrator to properly set the expectations of the administrator as to the likely nature of the upgrade process upon the customized instance of the application. In a more complex form, the report can be provided to a rules engine that can permit an administrator to perform the upgrade conditioned upon favorable predictors. In the latter circumstance, the rules engine can require authorization by a second administrator in order to proceed with upgrading a customized form of the instance of the application where the predictors are less than favorable. In even yet another circumstance, the ability to proceed in upgrading the customized form of the application instance can be blocked where the predictors are not favorable.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for application upgrade feasibility and reporting, the method comprising:
generating in memory of a computing system a deployment characterization of a customized instance of a computer program designated to receive an upgrade;
comparing the deployment characterization to a selection of known characterizations of deployment of different customized instances of the computer program, each of the characterization having an association with an upgrade feasibility predictor for the upgrade;
identifying a matching one of the known characterizations for the generated deployment characterization; and,
displaying a report on a display of the computing system including an upgrade feasibility predictor corresponding to the matching one of the known characterization.

2. The method of claim 1, wherein the deployment characterization comprises an inventory of components included as part of the customized instance of the computer program.

3. The method of claim 1, wherein the deployment characterization comprises an inventory of components upon which the instance of the computer program is dependent.

4. The method of claim 1, wherein the deployment characterization comprises an inventory of ones of the components that have been modified from a default form of the components.

5. The method of claim 1, wherein the upgrade feasibility predictor comprises an indicator selected from the group consisting of recommended, not recommended, and recommended with caution.

6. The method of claim 1, wherein a hyperlinked reference to crowd-sourced documentation pertaining to particular upgrade issues for the deployment characterization arising from attempting the upgrade is included in the report.

7. An application deployment data processing system configured for application upgrade feasibility and reporting, the system comprising:
a host computing system comprising at least one computer with memory and at least one processor;
a data store coupled to the host computing system;
a customized instance of a computer program comprising a plurality of components stored in the data store; and,
an upgrade feasibility module executing in the memory of the host computing system, the module comprising program code enabled upon execution by the at least one processor to generate in the memory a deployment characterization of the customized instance of the computer program designated to receive an upgrade, to compare the deployment characterization to a selection of known characterizations of deployment of different customized instances of the computer program stored in the data store, each of the characterization having an association with an upgrade feasibility predictor for the upgrade, to identify a matching one of the known characterizations for the generated deployment characterization and to display a report on a display of the host computing system including an upgrade feasibility predictor corresponding to the matching one of the known characterization.

8. The system of claim 7, wherein the deployment characterization comprises an inventory of the components included as part of the customized instance of the computer program.

9. The system of claim 7, wherein the deployment characterization comprises an inventory of other components upon which the instance of the computer program is dependent.

10. The system of claim 7, wherein the deployment characterization comprises an inventory of ones of the components that have been modified from a default form of the components.

11. The system of claim 7, wherein the upgrade feasibility predictor comprises an indicator selected from the group consisting of recommended, not recommended, and recommended with caution.

12. The system of claim 7, wherein a hyperlinked reference to crowd-sourced documentation pertaining to particular upgrade issues for the deployment characterization arising from attempting the upgrade is included in the report.

13. A computer program product for application upgrade feasibility and reporting, the computer program product comprising a computer readable storage medium having program instructions embodied therewith, the program instructions executable by a device to cause the device to perform a method comprising:
generating by a device in memory of a computing system a deployment characterization of a customized instance of a computer program designated to receive an upgrade;
comparing by the device the deployment characterization to a selection of known characterizations of deployment of different customized instances of the computer program, each of the characterization having an association with an upgrade feasibility predictor for the upgrade;
identifying by the device a matching one of the known characterizations for the generated deployment characterization; and,
displaying by the device a report on a display of the computing system including an upgrade feasibility predictor corresponding to the matching one of the known characterization.

14. The computer program product of claim 13, wherein the deployment characterization comprises an inventory of components included as part of the customized instance of the computer program.

15. The computer program product of claim 13, wherein the deployment characterization comprises an inventory of components upon which the instance of the computer program is dependent.

16. The computer program product of claim 13, wherein the deployment characterization comprises an inventory of ones of the components that have been modified from a default form of the components.

17. The computer program product of claim 13, wherein the upgrade feasibility predictor comprises an indicator selected from the group consisting of recommended, not recommended, and recommended with caution.

18. The computer program product of claim 13, wherein a hyperlinked reference to crowd-sourced documentation pertaining to particular upgrade issues for the deployment characterization arising from attempting the upgrade is included in the report.
